(19) United States
(12) Patent Application Publication
(10) Pub. No.: US 2017/0347411 A1
(43) Pub. Date: Nov. 30, 2017

(54) COLOR DIMMING SYSTEM AND METHODS OF OPERATING THE SAME

(71) Applicant: Maxlite, Inc., West Caldwell, NJ (US)

(72) Inventor: Marc GALLO, Roseland, NJ (US)

(21) Appl. No.: 15/607,073

(22) Filed: May 26, 2017

Related U.S. Application Data
(60) Provisional application No. 62/342,327, filed on May 27, 2016.

(51) Int. Cl. H05B 33/08; H05B 37/02; F21Y 2113/17

(52) U.S. Cl. CPC H05B 33/086; H05B 37/02; H05B 33/0845; H05B 33/0824; H05B 33/0806; F21Y 2113/17

(57) ABSTRACT

A color tuning system including a first plurality of LEDs having a first color temperature, a second plurality of LEDs having a second color temperature, a wave generator electrically connected to the first plurality of LEDs and the second plurality of LEDs, where the waveform generator transmits a first signal to the first plurality of LEDs for a first predetermined time and a second signal to the second plurality of LEDs for a second predetermined time.

The present disclosure is a Non-Provisional patent application claiming the benefit of and priority to U.S. Provisional Patent Application No. 62/342,327 filed May 27, 2016, which is incorporated by reference herein in its entirety.

### BACKGROUND OF THE INVENTION

Color tuning is the process in which color temperature of an LED lamp is adjusted. The range of attainable color temperatures is somewhere between 1600K and 6500K. To control the color temperature of an LED, two sets of LEDs having different color temperatures are installed in a fixture to produce a combined color temperature. The intensity of each strip is adjusted by two independent lighting drivers until the desired color temperature is achieved.

Adjusting two independent LED drivers to obtain a desired color temperature adds complexity to the manufacturing process. Further, the use of two independent drivers presents problems when the fixture is dimmed. Therefore, a need exists for an LED fixture that allows for color temperature control from a single LED driver.

### BRIEF SUMMARY OF THE INVENTION

One embodiment of the present invention discloses a color tuning system including a first plurality of LEDs having a first color temperature, a second plurality of LEDs having a second color temperature, a wave generator electrically connected to the first plurality of LEDs and the second plurality of LEDs, where the waveform generator transmits a first signal to the first plurality of LEDs for a first predetermined time and a second signal to the second plurality of LEDs for a second predetermined time.

In another embodiment, a first transistor is connected to the waveform generator and the first plurality of LEDs.

In another embodiment, a second transistor is connected to the waveform generator and the second plurality of LEDs.

In another embodiment, the first signal transmitted from the wave from the waveform generator is sufficient to saturate the gate of the first transistor.

In another embodiment, the second signal transmitted from the wave from the waveform generator is sufficient to saturate the gate of the second transistor.

In another embodiment, the waveform generator does not transmit the first signal and second signal simultaneously.

In another embodiment, the first predetermined time and second predetermined time are adjusted to produce a predetermined color temperature from the first LEDs and second LEDs.

In another embodiment, the first color temperature has a different value than the second color temperature.

In another embodiment, the first duration is different than the second duration have a different value than the second duration.

In another embodiment, the first duration is the same as the second duration.

Another embodiment of the present disclosure includes a method of tuning the color produced by a fixture, the method including generating a first signal from a waveform generator to a first plurality of LEDs having a first color temperature and generating a second signal from a waveform generator to a second plurality of LEDs having a second color temperature wherein the waveform generator transmits a first signal to the first plurality of LEDs for a first predetermined time and a second signal to the second plurality of LEDs for a second predetermined time.

In another embodiment, a first transistor is connected to the waveform generator and the first plurality of LEDs.

In another embodiment, a second transistor connected to the waveform generator and the second plurality of LEDs.

In another embodiment, the first signal transmitted from the wave from the waveform generator is sufficient to saturate the gate of the first transistor.

In another embodiment, the second signal transmitted from the wave from the waveform generator is sufficient to saturate the gate of the second transistor.

In another embodiment, the waveform generator does not transmit the first signal and second signal simultaneously.

In another embodiment, the first predetermined time and second predetermined time are adjusted to produce a predetermined color temperature from the first LEDs and second LEDs.

In another embodiment, the first color temperature has a different value than the second color temperature.

In another embodiment, the first duration is different than the second duration have a different value than the second duration.

In another embodiment, the first duration is the same as the second duration

### BRIEF DESCRIPTION OF THE SEVERAL VIEWS OF THE DRAWING

FIG. 1 depicts a schematic representation of the color tuning system;

FIG. 2 depicts one embodiment of a control circuit used to control the color temperature of a fixture;

FIG. 3 depicts a schematic representation of the operation of the control circuit;

FIG. 4 depicts a schematic representation of a pulse width signal sent to the first transistor and second transistor;

FIG. 5 depicts another embodiment of a pulse signal sent to the first transistor and second transistor; [[and]]

FIG. 6 depicts a schematic representation of the color tuning system of FIG. 1 including dimming control;

FIG. 7 depicts a two wire arrangement of LEDs. In this arrangement the LEDS 104 and 106 are arranged in reverse parallel;

FIG. 8A depicts a H bridge wiring arrangement; and

FIG. 8B depicts a chart showing the cycling of transistors.

### DETAILED DESCRIPTION OF THE INVENTION

Described herein is a color tuning system that utilizes a single LED driver to control the color of two independent LED strips having different color temperatures. The LED driver uses matched pulse signals to toggle between the LED strips to achieve a desired color temperature. Further, as the pulse signal dynamically adjusts the color of fixture by toggling the duration each LED strip is illuminated, the color of the fixture as a whole can be adjusted.

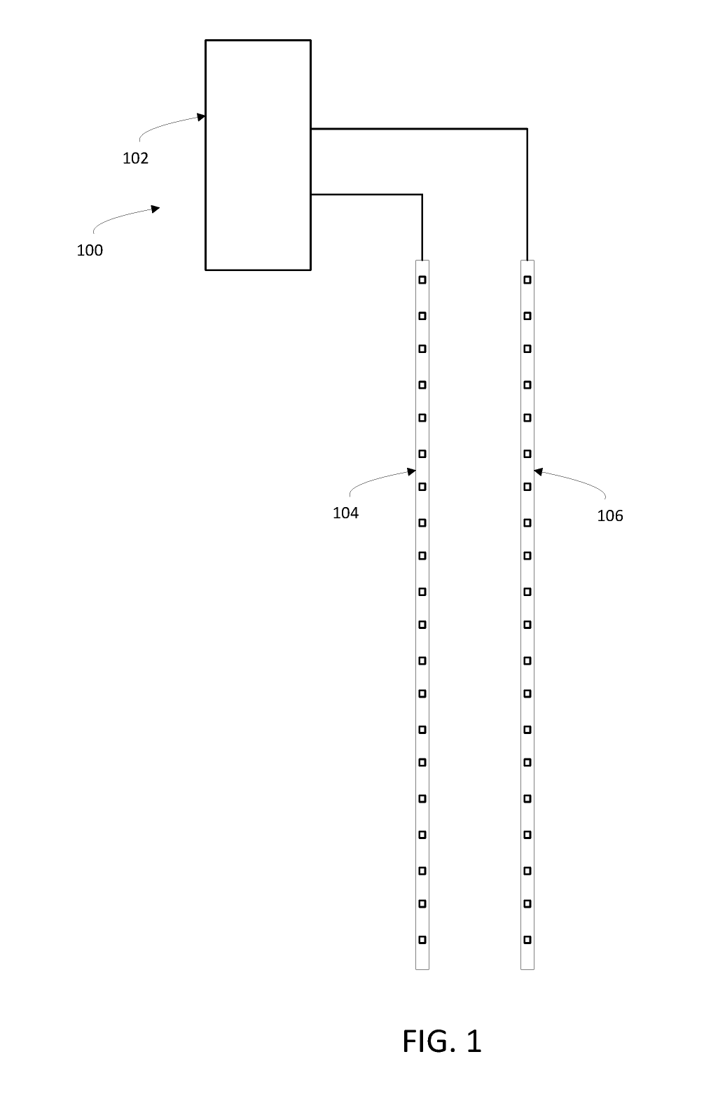

FIG. 1 depicts a schematic representation of the color tuning system. The color tuning 100 system includes a LED driver 102, a first LED strip 104 having a first color temperature and a second color strip 106 having a second color temperature. The LED driver 102 alternates signals to each of the first LED strip 104 and second LED strip 106. Each LED strip includes a plurality of LEDs electrically connected together. By adjusting the time base of the signal sent to the first LED strip 104 and second LED strip 106, the color of the light emitted from the LED strips 104 and 106 can be adjusted. Further, the color temperature can be modulated between the color temperature of the low color LED and the color temperature of the high color LED.

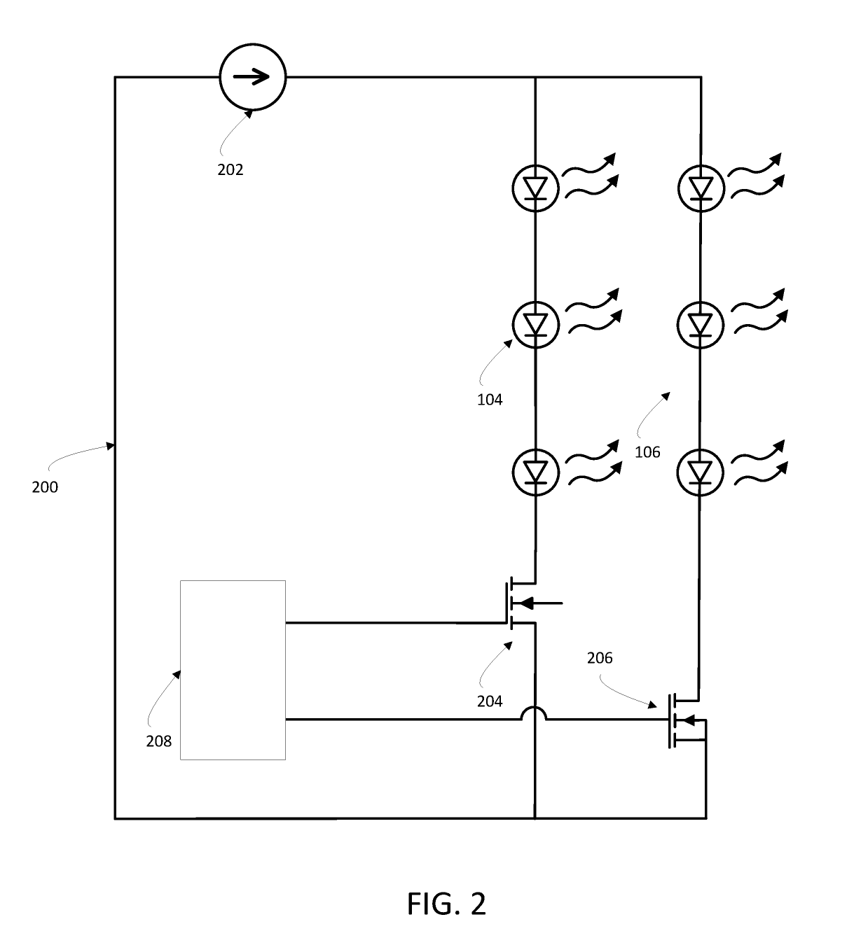

FIG. 2 depicts one embodiment of a control circuit used to control the color temperature of a fixture. The control circuit 200 includes a constant current unit 202 electrically connected to the input of a first LED strip 104 and to the input of a second LED strip 106. The constant current unit 202 is configured to provide a constant current to the first LED strip and second LED strip. The drain of a first transistor 204 is connected to the output of the first LED strip 104 and the drain of a second transistor 206 is connect to the output of the second LED strip 106. The gates of the first transistor 204 and second transistor 206 are each connected to separate outputs of a waveform generator 208. In one embodiment, the first transistor 204 and second transistor 206 are N Type MOSFET transistors. In one embodiment, the first LED strip 104 has a higher color temperature than the second LED strip 106. In another embodiment, the second LED strip 106 has a higher color temperature than the first LED strip 104. During operation, the waveform generator 208 transmits signals to the first transistor 204 and second transistor 206 to toggle each LED strip 104 and 106 on and off.

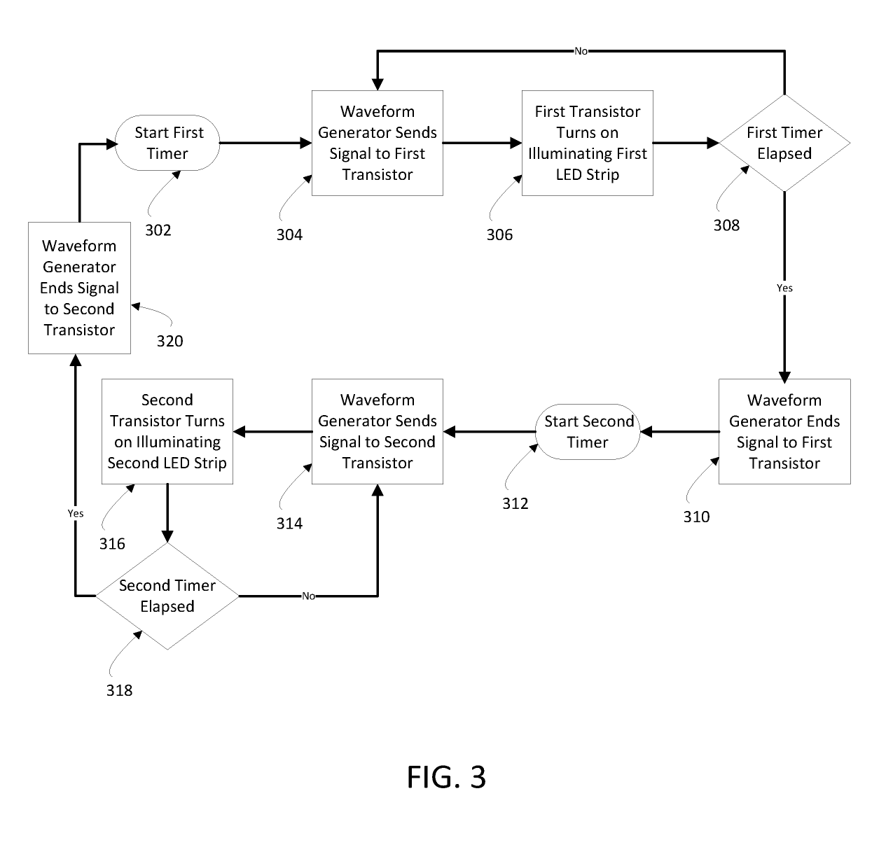

FIG. 3 depicts a schematic representation of the operation of the control circuit. In step 302, a first timer in the waveform generator 208 is initiated. In step 304, the waveform generator transmits a first signal to the first transistor 204 and does not transmit a signal to the second transistor 206. The first signal sent to the first transistor 204 is sufficient to saturate the gate of the first transistor 204 to generate current flow through the transistor 204. In step 306, the first transistor 204 begins conducting current, completing the circuit between the first LED string 104 and the constant current driver 202, thereby illuminating the first LED string 104 In step 308, the waveform generator 208 determines if the first timer has elapsed. If the first timer has not elapsed, the waveform generator 208 continues to transmit the signal to the first transistor 204. If the first timer has elapsed, the waveform generator stops transmitting the signal to the first transistor in step 310.

In step 312, the waveform generator initiates a second timer. In step 314, the waveform generator 208 transmits a second signal to the second transistor 206. The second signal sent to the second transistor 206 is sufficient to saturate the gate of the second transistor 206 to generate current flow through the second transistor 206. In step 316, the second transistor 206 begins conducting current, completing the circuit between the second LED string 106 and the constant current driver 202, thereby illuminating the second LED string 106. In step 318, the waveform generator 208 determines if the second timer has elapsed. In step 320, if the second timer has elapse, the waveform generator 208 stops transmitting the signal to the second transistor 206 and the first timer is started. If the timer has not elapsed, the waveform generator 208 continues to transmit the signal to the second transistor 206.

By adjusting the duration of the first timer and second timer, the amount of time the first LED strip 104 and second LED strip 106 are illuminated can be controlled. By controlling the duration each LED strip is illuminated, the color of the light produced by the LED strips 104 and 106 can be adjusted. As an illustrative example, by illuminating the strip 104 or 106 with a high color temperature longer than the strip 104 or 106 with a lower color temperature, the produced light will have a color temperature higher than the lower temperature strip 104 or 106 and less than the color temperature of the higher color temperature strip 104 or 106. In one embodiment, the waveform generator receives a signal, analog or digital, from an external device that adjusts the times T1 and T2 to achieve a specific color temperature. In another embodiment, the waveform generator 208 receives a color temperature set point from an external source. Consistent with this embodiment, the waveform generator 208 adjusts the times T1 and T2 to achieve the color temperature set point.

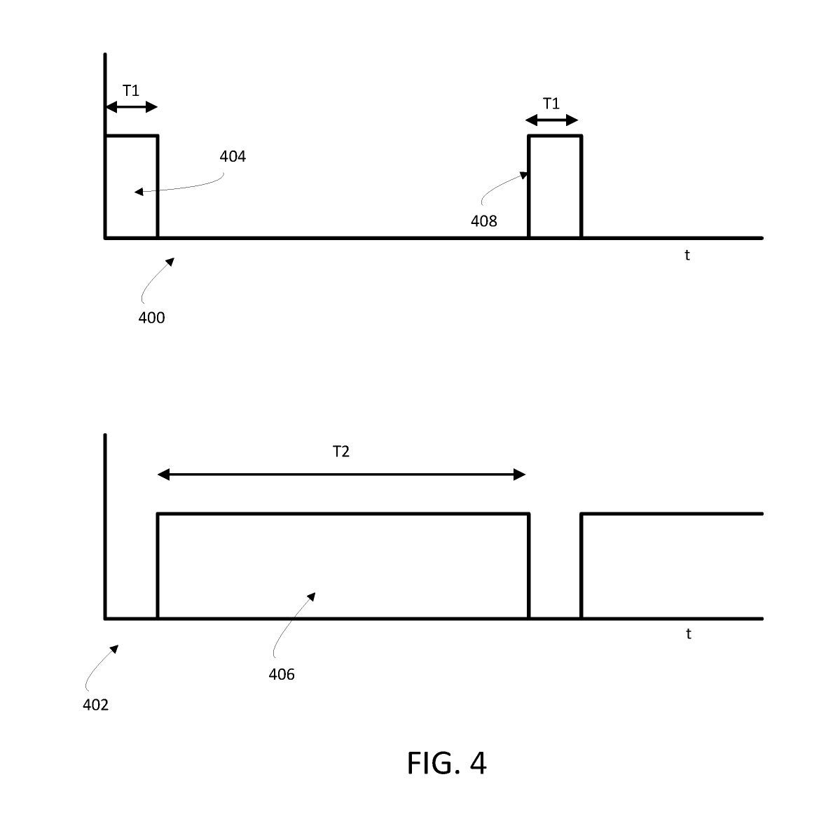

FIG. 4 depicts a schematic representation of a pulse width signal sent to the first transistor 204 and second transistor 206. The waveform generator 208 may transmit a pulse width modulated signal to the first transistor 204 and second transistor 206 as represented by the signals shown in graph 400 and graph 402 respectively. The waveform generator 208 transmits a first signal 404 to the first transistor 204 for a predetermined time T1. After the time T1 has elapsed, the waveform generator 208 transmits a signal to the second transistor 206 for a predetermined time T2. In one embodiment, the waveform generator 208 transmits one signal to the first transistor 204 or the second transistor 206. In another embodiment, the waveform generator 208 sends different signals to the first transistor 204 and second transistor 206 simultaneously. By adjusting the times T1 and T2, the color temperature of the light produced by the first LED strip 104 and second LED strip 106 can be controlled. Further, by quickly switching between one LED strip and another, the In one embodiment, the time T1 is approximately lμ second and the time T2 is 1 m second.

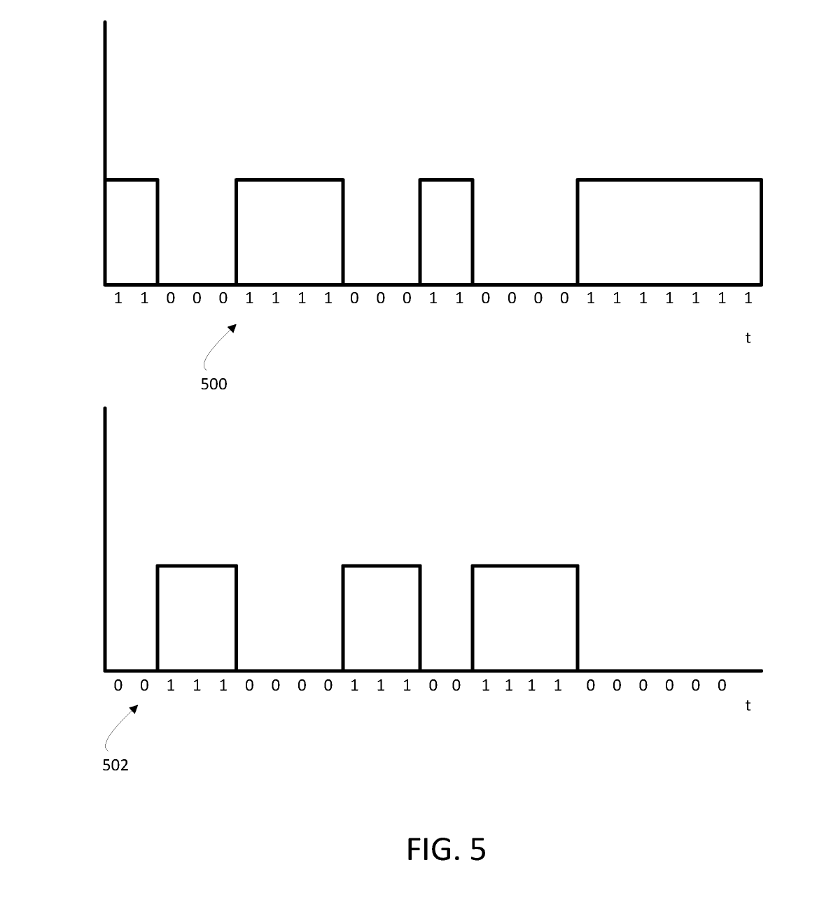

FIG. 5 depicts another embodiment of a pulse signal sent to the first transistor 204 and second transistor 206. The signals may be transmitted using pulse density modulation where the amount of time a signal is sent to the first transistor 204 or second transistor are adjusted to reduce flicker in the light. Graphs 500 and 502 show a pulse density modulated signal being sent to the first transducer 204 and the second transducer 206.

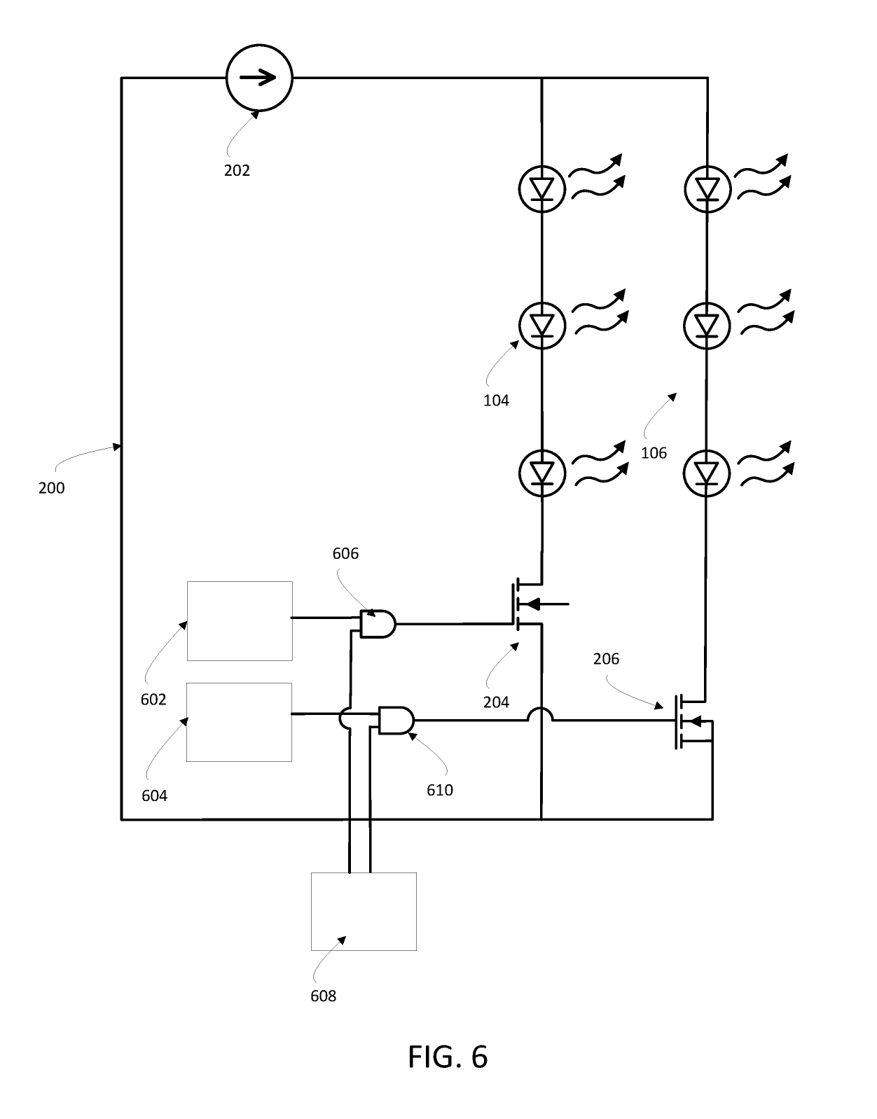

FIG. 6 depicts a schematic representation of the color tuning system of FIG. 1 including dimming control. A first wave form generator 602 is connected to a first port of an AND gate 606 and then to transistor 204. A second wave form generator 604 is connected to a first port of a second AND gate 610. A dimmer signal transmitted from a dimmer unit 608 is connected to the second ports of the first and second AND gates 606 and 608. The signals generated from the first waveform generator 602 are alternated with the signals generated by the second waveform generator 604 such that only one generator is producing a signal at a time. The dimming signal from the dimming unit 610 has a constant time base and pitch.

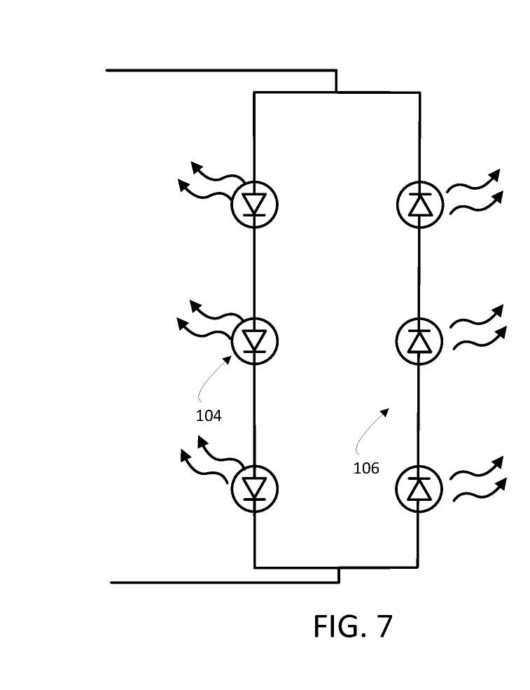

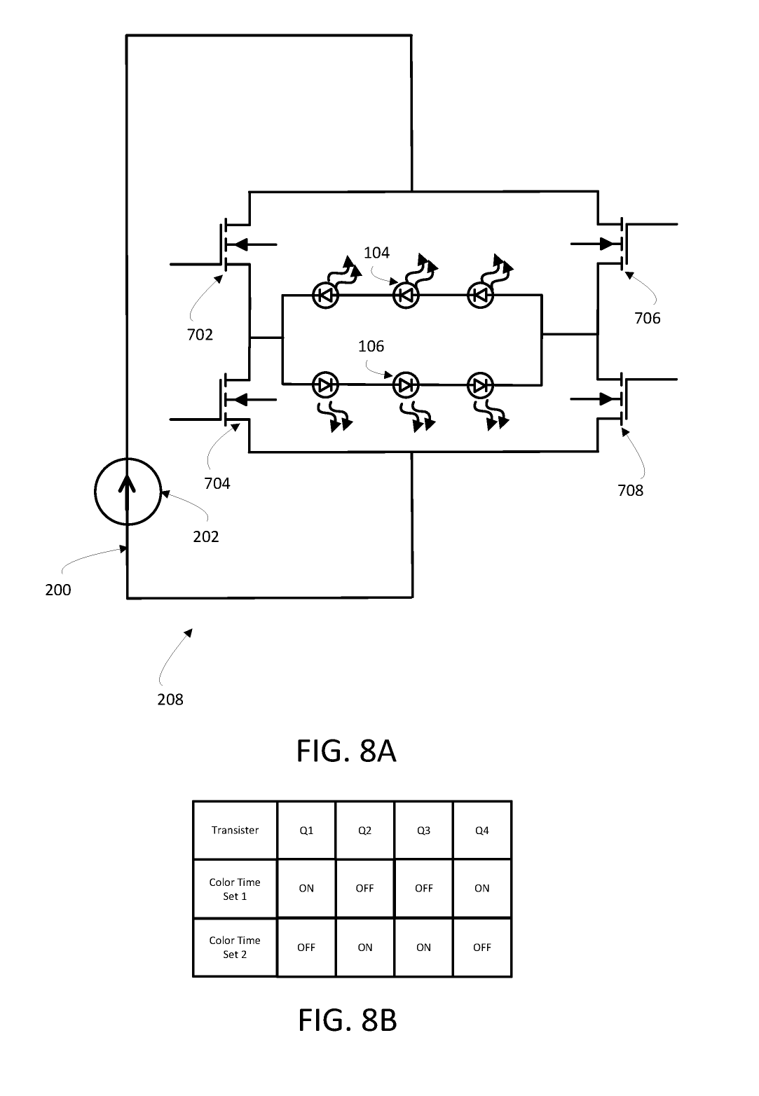

FIG. 7 depicts a two wire arrangement of LEDs. In this arrangement the LEDS 104 and 106 are arranged in reverse parallel. FIG. 8A depicts a H bridge wiring arrangement. Consistent with this embodiment, the first and second LEDs 104 and 106 are arranged in the two wire arrangement in FIG. 7 with the LED arrangement is connected to a first transistor 702, second transistor 704, third transistor 706 and fourth transistor 708. The transistors 702, 704, 706 and 708 a cycled based on the chart shown in FIG. 8B. By adjusting the duration each set of transistors is on or off, the temperature of the color generated by the fixture is changed.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. A color tuning system including:
a first plurality of LEDs having a first color temperature;
a second plurality of LEDs having a second color temperature;
a wave generator electrically connected to the first plurality of LEDs and the second plurality of LEDs,
wherein the waveform generator transmits a first signal to the first plurality of LEDs for a first predetermined time and a second signal to the second plurality of LEDs for a second predetermined time.

2. The color tuning system of claim 1 including a first transistor connected to the waveform generator and the first plurality of LEDs.

3. The color tuning system of claim 2 including a second transistor connected to the waveform generator and the second plurality of LEDs.

4. The color tuning system of claim 2 wherein the first signal transmitted from the wave from the waveform generator is sufficient to saturate the gate of the first transistor.

5. The color tuning system of claim 4 wherein the second signal transmitted from the wave from the waveform generator is sufficient to saturate the gate of the second transistor.

6. The color tuning system of claim 1 wherein the waveform generator does not transmit the first signal and second signal simultaneously.

7. The color tuning system of claim 1 wherein the first predetermined time and second predetermined time are adjusted to produce a predetermined color temperature from the first LEDs and second LEDs.

8. The color tuning system of claim 1 wherein the first color temperature has a different value than the second color temperature.

9. The color tuning system of claim 1 wherein the first duration is different than the second duration have a different value than the second duration.

10. The color tuning system of claim 1 wherein the first duration is the same as the second duration.

11. A method of tuning the color produced by a fixture, the method including:
generating a first signal from a waveform generator to a first plurality of LEDs having a first color temperature;
generating a second signal from a waveform generator to a second plurality of LEDs having a second color temperature;
wherein the waveform generator transmits a first signal to the first plurality of LEDs for a first predetermined time and a second signal to the second plurality of LEDs for a second predetermined time.

12. The method of claim 11 wherein a first transistor is connected to the waveform generator and the first plurality of LEDs.

13. The method of 12 including a second transistor connected to the waveform generator and the second plurality of LEDs.

14. The method of claim 13 wherein the first signal transmitted from the wave from the waveform generator is sufficient to saturate the gate of the first transistor.

15. The method of claim 14 wherein the second signal transmitted from the wave from the waveform generator is sufficient to saturate the gate of the second transistor.

16. The method of claim 11 wherein the waveform generator does not transmit the first signal and second signal simultaneously.

17. The method of claim 11 wherein the first predetermined time and second predetermined time are adjusted to produce a predetermined color temperature from the first LEDs and second LEDs.

18. The method of claim 11 wherein the first color temperature has a different value than the second color temperature.

19. The method of claim 11 wherein the first duration is different than the second duration have a different value than the second duration.

20. The method of claim 11 wherein the first duration is the same as the second duration
